(19) United States
(12) Patent Application Publication
(10) Pub. No.: US 2023/0254032 A1
(43) Pub. Date: Aug. 10, 2023

(54) ANTENNA DIRECTION ADJUSTING METHOD, PORTABLE STATION DEVICE AND ANTENNA DIRECTION ADJUSTING PROGRAM IN SATELLITE COMMUNICATION SYSTEM

(71) Applicant: NIPPON TELEGRAPH AND TELEPHONE CORPORATION, Tokyo (JP)

(72) Inventors: Koichi HARADA, Musashino-shi, Tokyo (JP); Masaki SHIMA, Musashino-shi, Tokyo (JP); Hiroki SHIBAYAMA, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 18/008,738

(22) PCT Filed: Jun. 10, 2020
(86) PCT No.: PCT/JP2020/022878

§ 371 Date: Dec. 7, 2022

(51) Int. Cl. H04B 7/185

(52) U.S. Cl. CPC H04B 7/18519; H04B 7/18528

(57) ABSTRACT

A portable station device performs: a coarse adjustment to the antenna direction of a target communication satellite, the antenna direction being calculated based on the longitude of the target communication satellite from satellite information about the longitudes of communication satellites, a beacon signal, and a telemetry signal and the installation location of the portable station device; measurement of the frequencies of the beacon signal and the telemetry signal; determination of whether the measured frequencies of the beacon signal and the telemetry signal are correct or not with reference to the frequencies of the beacon signal and the telemetry signal of the target communication satellite in the satellite information; and a fine adjustment on the antenna direction such that the beacon signal received in the coarsely adjusted antenna direction reaches the highest reception level, if the determination is correct.

### TECHNICAL FIELD

The present invention relates to a technique of adjusting the direction of an antenna when a portable earth-station device is initially connected to a communication satellite in a satellite communication system while the communication system loses contact with a satellite communication provider due to a wide scale disaster or the like.

### BACKGROUND ART

As a satellite communication system provided with a portable earth-station device, a VSAT (Very Small Aperture Terminal) system is known. A VSAT system with a portable and small VSAT earth-station device including a very small aperture antenna can perform communications from a location where a communication satellite can be acquired. Thus, such a VSAT system is used for secure communications during a disaster. However, the installation of a portable earth-station device (will be referred to as a portable station device) requires the adjustment of antenna direction relative to a target communication satellite at the start of an operation. The antenna direction is determined by calculation based on, for example, the geographical position (latitude/longitude) of the device and information (longitude) about the target communication satellite. The geographical position of the portable station device is obtained from, for example, GPS (Global Positioning System). The antenna of the portable station device is coarsely adjusted to the direction determined by the calculation, and then fine adjustments are made on the azimuth angle, the elevation angle, and the polarization angle of the antenna such that a beacon signal transmitted from the communication satellite reaches the highest level (for example, see PTL 1). After the antenna direction is adjusted, the portable station device confirms the target communication satellite by receiving a control signal transmitted from a base station device and obtaining synchronization, and then terminates processing for the start of the operation.

### CITATION LIST

### Patent Literature

[PTL 1] Japanese Patent No. 5592983

### SUMMARY OF THE INVENTION

### Technical Problem

If the use of a control signal from the base station device is interrupted by a wide scale disaster or the like, a portable station device can be selected among a plurality of portable station devices and used as a base station device to communicate with other portable station devices. In this case, the portable station device used as the base station device cannot make a final confirmation based on the control signal, resulting in the need for acquiring a target communication satellite based on the beacon signal of the communication satellite.

However, in the presence of multiple communication satellites with beacon signals of overlapping frequencies, whether a communication satellite with adjusted antenna direction is a target communication satellite or not cannot be confirmed. Thus, another communication satellite that transmits a beacon signal at the same frequency may be accidentally acquired.

An object of the present invention is to provide an antenna direction adjusting method, a portable station device and an antenna direction adjusting program in a satellite communication system that can securely acquire a target communication satellite based on a combination of the frequencies of a beacon signal and a telemetry signal even if the use of the control signal of a base station device is interrupted by a wide scale disaster or the like.

### Means for Solving the Problem

The present invention is an antenna direction adjusting method in a satellite communication system including a portable station device the portable station device being characterized by performing: a coarse adjustment in which an antenna direction is calculated relative to a target communication satellite based on the longitude of the target communication satellite from satellite information about the longitudes of a plurality of communication satellites, a beacon signal, and a telemetry signal and the installation position of the portable station device and an antenna direction of the portable station device is coarsely adjusted to the calculated antenna direction; measurement of the frequencies of the beacon signal and the telemetry signal that are received in the coarsely adjusted antenna direction; determination of whether the measured frequencies of the beacon signal and the telemetry signal in the measurement are correct or not with reference to the frequencies of the beacon signal and the telemetry signal of the target communication satellite, the frequencies being stored in the satellite information; and a fine adjustment on the antenna direction such that the beacon signal received in the coarsely adjusted antenna direction reaches the highest reception level, if the measured frequencies of the beacon signal and the telemetry signal in the measurement are correct.

The present invention is a portable station device used in a satellite communication system, the portable station device being characterized by including a storage unit in which satellite information about the longitudes of a plurality of communication satellites, a beacon signal, and a telemetry signal is stored; a measuring unit for receiving the beacon signal and the telemetry signal from the communication satellite and measuring frequencies of the signals; and a control unit for performing: a coarse adjustment in which an antenna direction is calculated relative to a target communication satellite based on the longitude of the target communication satellite from satellite information and the installation position of the portable station device and an antenna direction of the portable station device is coarsely adjusted to the antenna direction calculated by controlling a drive unit in the antenna direction; determination of whether the frequencies measured by the measuring unit for the beacon signal and the telemetry signal are correct or not with reference to the frequencies of the beacon signal and the telemetry signal of the target communication satellite, the frequencies being stored in the satellite information; and a fine adjustment on the antenna direction such that the beacon signal received in the coarsely adjusted antenna direction reaches the highest reception level, if the frequencies measured by the measuring unit for the beacon signal and the telemetry signal are correct.

An antenna direction adjusting program according to the present invention is characterized by causing a computer to perform processing performed by the control unit of the portable station device.

### Effects of the Invention

An antenna direction adjusting method, a portable station device and an antenna direction adjusting program in a satellite communication system according to the present invention can securely acquire a target communication satellite based on a combination of the frequencies of a beacon signal and a telemetry signal even if the use of the control signal of a base station device is interrupted by a wide scale disaster or the like.

### BRIEF DESCRIPTION OF DRAWINGS

FIG. 1 illustrates an example of a satellite communication system according to the present embodiment.

FIG. 2 illustrates an example of a typical satellite communication system.

FIG. 3 illustrates a layout example of a plurality of communication satellites.

FIG. 4 illustrates an example of a satellite information table.

FIG. 5 illustrates a configuration example of a master station device.

FIG. 6 illustrates a configuration example of a slave station device.

FIG. 7 illustrates an example of the adjustment of an antenna direction (1/2).

FIG. 8 illustrates the example of the adjustment of the antenna direction (2/2).

### DESCRIPTION OF EMBODIMENTS

An embodiment of an antenna direction adjusting method, a portable station device and an antenna direction adjusting program in a satellite communication system according to the present invention will be described below with reference to the accompanying drawings.

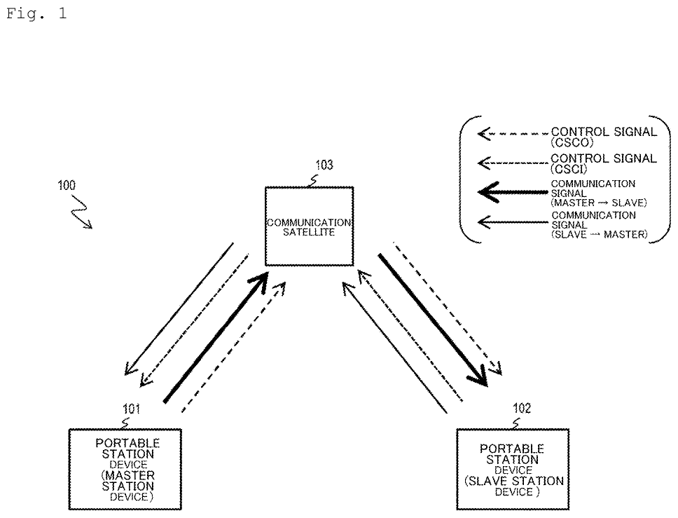

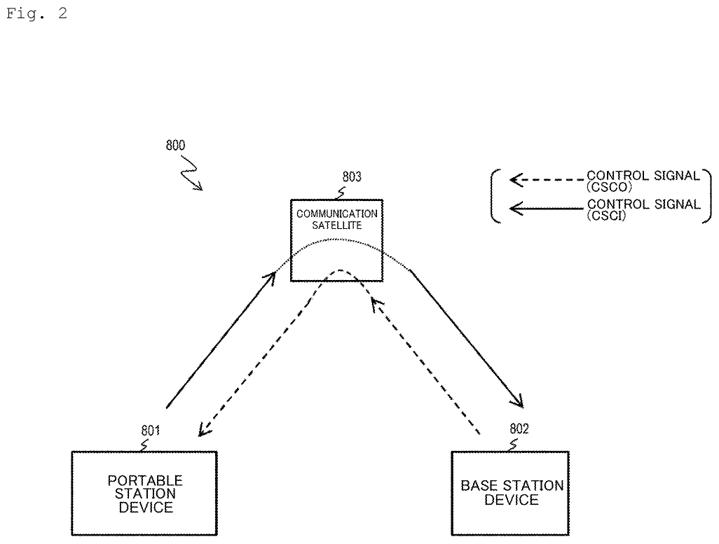

FIG. 1 illustrates an example of a satellite communication system 100 according to the present embodiment. In the present embodiment, for example, the satellite communication system 100 is configured as follows: Any one of a plurality of portable station devices (a portable station device 101 in FIG. 1) acts as a master station device corresponding to the control station device and the base station device of a typical VSAT system. The portable station devices other than the master station device (a portable station device 102 in FIG. 2) is a slave station device corresponding to the VSAT earth station device of a typical VSAT system. In the satellite communication system 100, the portable station device 101 of the master station device and the portable station device 102 of the slave station device construct a private network through P-P communications or P-MP communications without an operation system for, for example, a control station device in a wide scale disaster or the like.

Hereinafter, the portable station device 101 of the master station device will be referred to as a master station device 101, and the portable station device 102 of the slave station device will be referred to as a slave station device 102.

In the satellite communication system 100 of FIG. 1, the slave station device 102 can obtain synchronization using a control signal transmitted from the master station device 101 via a communication satellite 103 and transmit and receive a communication signal to and from the master station device 101. Also in the case of a plurality of slave station devices identical to the slave station device 102, each of the slave station devices can similarly obtain synchronization using the control signal of the master station device 101 and transmit and receive a communication signal to and from the master station device 101.

In FIG. 1, the satellite communication system 100 including a plurality of portable earth-station devices (the portable station device 101 and the portable station device 102 in FIG. 1) can be used at a location where the communication satellite 103 can be acquired. Thus, the satellite communication system 100 is effective for securing communications during a disaster. However, if the transmission and reception of the control signal to and from the base station device is interrupted by a wide scale disaster or the like, the master station device 101 needs to adjust antenna direction relative to the target communication satellite 103.

FIG. 2 illustrates an example of a typical satellite communication system 800. In FIG. 2, the satellite communication system 800 includes a portable station device 801, a base station device 802, and a communication satellite 803. The base station device 802 always transmits the control signal (CSCO signal). After the antenna direction is adjusted, the portable station device 801 receives the CSCO signal of the base station device 802 and obtains synchronization with the base station device 802, thereby securely acquiring the target communication satellite 803 and capable of communicating with the base station device 802. However, if the transmission and reception of the control signal to and from the base station device is interrupted by a wide scale disaster or the like, it is difficult to acquire the target communication satellite 803 and communicate with the base station device 802.

In contrast, in the satellite communication system 100 illustrated in FIG. 1, even if the transmission and reception of the control signal to and from the base station device is interrupted by a wide scale disaster or the like, one of the portable station devices (the portable station device 101 in FIG. 1) acts as the master station device 101 to perform the operations of the base station device and the control station device. The master station device 101 acquires the target communication satellite 103 based on a beacon signal and a telemetry signal, whereas the slave station device 102 acquires the target communication satellite 103 by transmitting and receiving the control signal to and from the master station device 101 to obtain synchronization.

In FIG. 1, the master station device 101 has a satellite database in which satellite information including the longitudes of communication satellites, a beacon signal, and a telemetry signal is stored in advance. In this case, information about the beacon signal and the telemetry signal indicates the frequencies of V polarization and H polarization of the respective signals. The beacon signal is a CW (Continuous Wave) signal at a predetermined frequency, whereas the telemetry signal is a signal at a predetermined frequency for monitoring a state (e.g., a temperature or an electrically measured value) of a communication satellite.

The master station device 101 calculates antenna direction relative to a target communication satellite based on the longitude of the target communication satellite and the installation location of the master station device 101 and coarsely adjusts the antenna direction of the master station device 101. The longitude of the target communication satellite is obtained from the satellite information stored in the satellite database.

The master station device 101 determines whether a combination of a frequency including the polarization of the beacon signal and a frequency including the polarization of the telemetry signal agrees with a combination of the frequencies of the target communication satellite. The frequencies of the beacon signal and the telemetry signal are measured after the coarse adjustment, and the frequencies of the target communication satellite are stored in the satellite database. If the combination of the measured frequencies agrees with the combination of the stored frequencies of the target communication satellite 103 in the satellite database, the master station device 101 can confirm that the coarsely adjusted antenna direction is an antenna direction relative to the target communication satellite 103. Moreover, the master station device 101 makes a fine adjustment on the antenna direction such that the beacon signal received in the coarsely adjusted antenna direction reaches the highest reception level. If the combination of the measured frequencies does not agree with the combination of the stored frequencies of the target communication satellite 103 in the satellite database, the master station device 101 makes a coarse adjustment on the antenna direction again and performs the same processing.

In this way, the satellite communication system 100 according to the present embodiment can acquire the target communication satellite 103 by adjusting the antenna direction even if the control signal of the base station device cannot be used or even if beacon frequencies overlap each other in multiple communication satellites. Like the typical portable station device 801 illustrated in FIG. 2, the slave station device 102 replaces the base station device 802 and transmits and receives the control signal to and from the master station device 101 to obtain synchronization with the master station device 101, thereby securely acquiring the target communication satellite 103.

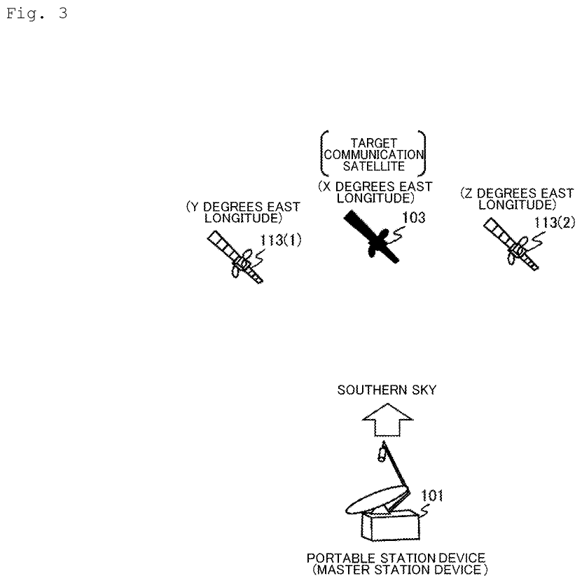

FIG. 3 illustrates a layout example of the communication satellites. For example, in FIG. 3, the master station device 101 (portable station device 101) is installed on the ground in Japan, and three communication satellites, communication satellites 113(1) and 113(2) including the target communication satellite 103 are located in different directions east longitude in the southern sky. In FIG. 3, the target communication satellite 103 is located at X degrees east longitude, the communication satellite 113(1) is located at Y degrees east longitude, and the communication satellite 113(2) is located at Z degrees east longitude.

In this case, the master station device 101 adjusts the antenna direction to acquire the target communication satellite 103 from among the communication satellites in the southern sky.

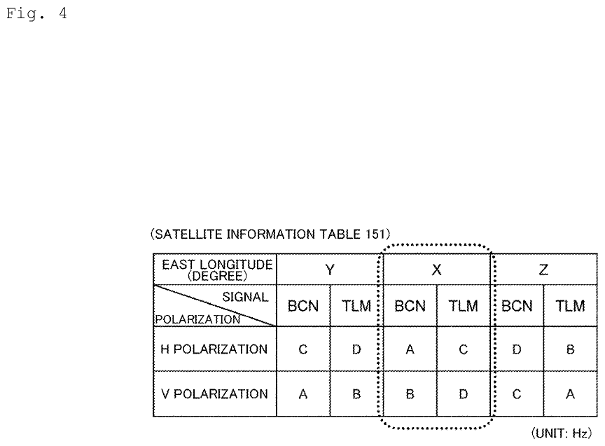

FIG. 4 illustrates an example of a satellite information table 151. In the satellite information table 151, satellite information about the communication satellites illustrated in FIG. 3 is registered in advance. The three communication satellites in FIG. 4 correspond to the three communication satellites in FIG. 3.

In FIG. 4, the satellite information table 151 describes, about the satellites, east longitude (degrees), the frequency (Hz) of H polarization and the frequency (Hz) of V polarization for the beacon signal, and the frequency (Hz) of H polarization and the frequency (Hz) of V polarization for the telemetry signal. In the table, BCN represents the beacon signal while TLM represents the telemetry signal.

For example, in the satellite information table 151 of FIG. 4, AHz as the frequency of BCN of H polarization, BHz as the frequency of BCN of V polarization, CHz as the frequency of TLM of H polarization, and DHz as the frequency of TLM of V polarization are stored as information about the target communication satellite 103 at X degrees east longitude. Moreover, CHz as the frequency of BCN of H polarization, AHz as the frequency of BCN of V polarization, DHz as the frequency of TLM of H polarization, and BHz as the frequency of TLM of V polarization are stored as information about the communication satellite at Y degrees east longitude. Likewise, DHz as the frequency of BCN of H polarization, CHz as the frequency of BCN of V polarization, BHz as the frequency of TLM of H polarization, and AHz as the frequency of TLM of V polarization are stored as information about the communication satellite at Z degrees east longitude.

As indicated in FIG. 4, information that describes the beacon signal and the telemetry signal and is to be stored in the satellite information table 151 desirably includes both of H polarization and V polarization, but the information may only include H polarization or V polarization.

### Master Station Device 101

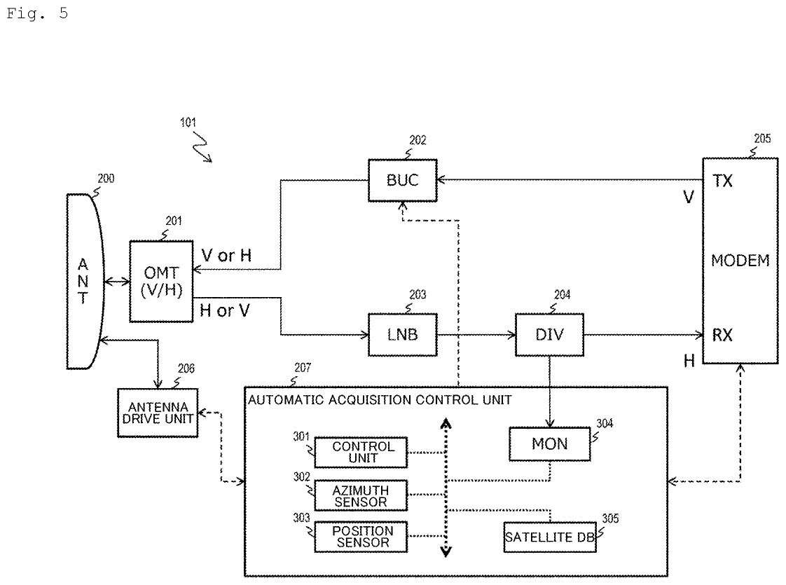

FIG. 5 illustrates a configuration example of the master station device 101. The master station device 101 includes an antenna (ANT) 200, a polarization coupler (OMT(V/H)) 201, a transmitter (BUC) 202, a low-noise amplifier (LNB) 203, a splitter (DIV) 204, a modulator-demodulator (MODEM) 205, an antenna drive unit 206, and an automatic acquisition control unit 207. In this configuration, the ANT 200 is rotated on a plane perpendicular to the traveling direction of radio waves, so that one of V polarization and H polarization is selected as the polarization of a transmitting system and a receiving system. Moreover, polarization in the facing direction is polarization relative to the traveling direction of radio waves. In the example of FIG. 5, the V polarization (H polarization) of radio waves transmitted to the communication satellite 103 is exerted in the facing direction while the H polarization (V polarization) of radio waves received from the communication satellite 103 is exerted in the facing direction.

The ANT 200 is, for example, a parabolic antenna. The ANT 200 has an antenna drive mechanism for adjusting the direction under the control of the antenna drive unit 206 and transmits and receives radio waves to and from the communication satellite 103. ANT is an abbreviation of ANTenna.

The OMT (V/H) 201 is a polarization coupler that separates a signal of V polarization and a signal of H polarization and functions in both directions of transmission and reception. For example, a signal of H polarization is outputted to the LNB 203 after being received by the ANT 200, and a signal transmitted from the BUC 202 is outputted as a signal of V polarization to the ANT 200. Alternatively, a signal of V polarization is outputted to the LNB 203 after being received by the ANT 200, and a signal transmitted from the BUC 202 is outputted as a signal of H polarization to the ANT 200. OMT is an abbreviation of Ortho Mode Transducer.

The BUC 202 is, for example, a transmitter with a combination of a frequency conversion function of converting a 1.2 GHz band signal, which is outputted from the MODEM 205, to the 14 GHz band and a high-power amplification function. BUC is an abbreviation of Block Up Converter.

The LNB 203 is a low-noise amplifier with a combination of the low-noise amplification of a 12 GHz band signal of H polarization (or V polarization) received by the ANT 200 and the function of frequency conversion to, for example, the 1.2 GHz band. LNB is an abbreviation of Low Noise Block converter.

The DIV 204 is a splitter that splits an inputted signal into two and outputs the signals. For example, the DIV 204 outputs the signal outputted from the LNB 203, to the MODEM 205 and a MON 304 of the automatic acquisition control unit 207. DIV is an abbreviation of DIVider.

The MODEM 205 is a modulator-demodulator that transmits a data signal modulated at a communication speed of, for example, 384 kbit/s, receives a modulated signal at a communication speed of 1.5 Mbit/s, and demodulates the signal into a data signal. MODEM is an abbreviation of MOdulator-DEModulator.

The antenna drive unit 206 operates the antenna drive mechanism of the ANT 200 based on a command of the automatic acquisition control unit 207 and adjusts the three directions of the azimuth angle, the elevation angle, and the polarization angle of the ANT 200. The azimuth angle is an angle (corresponding to the longitude) from the true north to the east around the antenna, the elevation angle is an angle from a horizontal plane to the above, and the polarization angle is an angle formed by the horizontal plane and the polarization plane of radio waves.

The automatic acquisition control unit 207 has a computer function of running a predetermined program, automatically acquires the communication satellite 103, and makes an adjustment and a confirmation during an operation. For example, the automatic acquisition control unit 207 controls the transmission level of the BUC 202 of the master station device 101, controls the modulation and demodulation of the MODEM 205, and controls the antenna drive unit 206.

In FIG. 5, the automatic acquisition control unit 207 includes a control unit 301, an azimuth sensor 302, a position sensor 303, the MON 304, and a satellite DB 305.

The control unit 301 corresponds to the CPU (Central Processing Unit) of a computer and operates based on a program stored therein. For example, the control unit 301 adjusts the antenna direction of the ANT 200 by means of the antenna drive unit 206 and communicates with the slave station device via the control signal in conjunction with the azimuth sensor 302, the position sensor 303, the MON 304, and the satellite DB 305. The control unit 301 also adjusts the transmission level of the BUC 202 and controls the MODEM 205 (transmits CW or specifies a modulation/demodulation method).

The azimuth sensor 302 is a sensor for measuring the azimuth angle of the ANT 200. For example, the azimuth sensor 302 measures the azimuth angle of the ANT 200, which is driven by the antenna drive unit 206, based on information obtained from a compass or the like. In this case, the azimuth angle corresponds to a longitude.

The position sensor 303 is a sensor for measuring the installation location (latitude/longitude) of the master station device 101 (ANT 200). For example, GPS (Global Positioning System) is used.

The MON 304 includes a measuring device (e.g., a spectrum analyzer) capable of measuring a reception level and a frequency. The MON 304 measures the reception level and the frequency of a signal of H polarization or V polarization, the signal being outputted from the DIV 204. In this case, the MON 304 corresponds to a measuring unit.

The satellite DB 305 is a database (corresponding to a storage unit) including storage media such as a hard disk and memory. For example, as satellite information about communication satellites including the target communication satellite 103, the satellite information table 151 illustrated in FIG. 4 is provided. The satellite information table 151 stores information such as position information (including east longitude) about satellites and information (including the frequencies of polarization) about the beacon signal and the telemetry signal.

In the adjustment of the antenna direction in FIG. 5, the control unit 301 calculates the antenna direction relative to the target communication satellite based on the installation location (latitude/longitude) of the master station device 101 and the longitude of the target communication satellite. The installation location of the master station device 101 is measured by the position sensor 303, and the longitude of the target communication satellite is stored in the satellite DB 305. Moreover, the master station device 101 issues a command to the antenna drive unit 206 to coarsely adjusts the direction of the ANT 200 to the calculated antenna direction.

After the coarse adjustment, the control unit 301 switches polarization received by the ANT 200 and measures the frequencies of the H polarization and the V polarization of the beacon signal and the telemetry signal by means of the MON 304. The control unit 301 then determines whether a combination of the frequencies measured by the MON 304 agrees with a combination of the frequencies of the target communication satellite 103. The frequencies of the target communication satellite 103 are stored in the satellite DB 305. If the combination of the measured frequencies agrees with the combination of the stored frequencies of the target communication satellite 103 in the satellite DB 305, the control unit 301 can determine that the coarsely adjusted antenna direction is an antenna direction relative to the target communication satellite 103.

For example, in the case of FIG. 4, if the frequencies of the beacon signal of H polarization and V polarization are AHz and BHz and the frequencies of the telemetry signal of H polarization and V polarization are CHz and DHz, the frequencies being monitored by the MON 304, it can be determined that the target communication satellite 103 has been acquired.

Moreover, the control unit 301 controls the antenna drive unit 206 to make a fine adjustment on the three directions of the azimuth angle, the elevation angle, and the polarization angle of the ANT 200 such that the beacon signal received in the coarsely adjusted antenna direction reaches the highest reception level.

In this way, the master station device 101 according to the present embodiment can securely acquire the target communication satellite 103 based on the frequencies of the polarization of the beacon signal and the telemetry signal.

### Slave Station Device 102

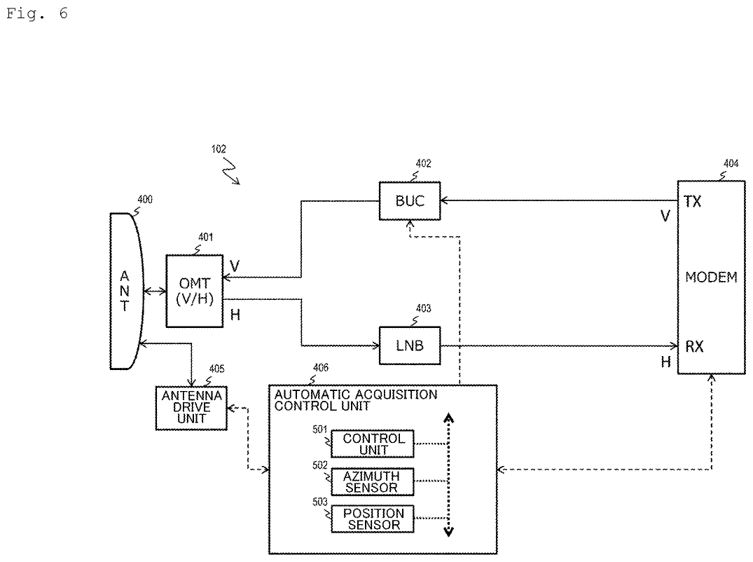

FIG. 6 illustrates a configuration example of the slave station device 102. The slave station device 102 includes an antenna (ANT) 400, a polarization coupler (OMT(V/H)) 401, a transmitter (BUC) 402, a low-noise amplifier (LNB) 403, a modulator-demodulator (MODEM) 404, an antenna drive unit 405, and an automatic acquisition control unit 406. FIG. 6 illustrates an example in which a transmitting system exerts V polarization and a receiving system exerts H polarization in the facing direction.

The slave station device 102 is configured like the typical portable station device 801. The slave station device 102 can obtain synchronization with the base station device 802 through communications using a control signal and transmit and receive a communication signal to and from the base station device 802. However, if the function of the base station device 802 is interrupted by a wide scale disaster or the like, the slave station device 102 communicates the control signal to another portable station device (the master station device 101 of the present embodiment) serving as a substitute for the function of the base station device 802 and obtains synchronization with the portable station device, thereby transmitting and receiving the communication signal.

In FIG. 6, the ANT 400, the OMT (V/H) 401, the BUC 402, the LNB 403, the MODEM 404, and the antenna drive unit 405 have the same functions as the ANT 200, the OMT (V/H) 201, the BUC 202, the LNB 203, the MODEM 205, and the antenna drive unit 206 that are illustrated in FIG. 5. The automatic acquisition control unit 406 includes a control unit 501, an azimuth sensor 502, and a position sensor 503. The azimuth sensor 502 and the position sensor 503 have the same functions as the azimuth sensor 302 and the position sensor 303 of the automatic acquisition control unit 207 illustrated in FIG. 5.

The control unit 501 calculates the three directions of the azimuth angle, the elevation angle, and the polarization angle of the ANT 400 to be adjusted and adjusts the direction of the ANT 400 by means of the antenna drive unit 405 such that the direction of the ANT 400 agrees with the direction of the target communication satellite 103. The direction of the target communication satellite 103 is stored in the satellite DB 305. The direction of the ANT 400 is calculated based on the installation location (latitude/longitude) of the slave station device 102 (ANT 400) and the current direction (longitude) of the ANT 400. The installation location of the slave station device 102 is obtained from the position sensor 503, and the current direction of the ANT 400 is obtained from the azimuth sensor 502. Thereafter, the control unit 501 receives the control signal (CSCO signal) from the master station device 101 via the MODEM 404 and obtains synchronization.

In this way, the slave station device 102 adjusts the antenna direction and obtains synchronization with the master station device 101, thereby communicating with the master station device 101 or other portable station devices.

The adjustment of the antenna direction of the master station device 101 in the satellite communication system 100 according to the present embodiment will be described below.

### Antenna Direction Adjustment

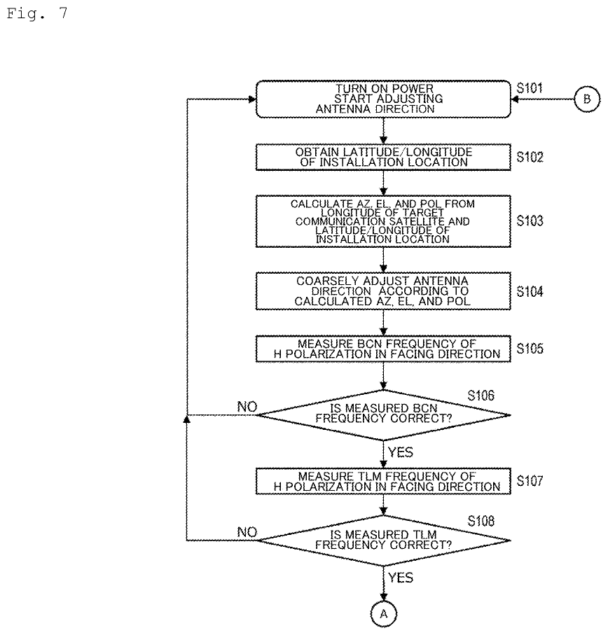

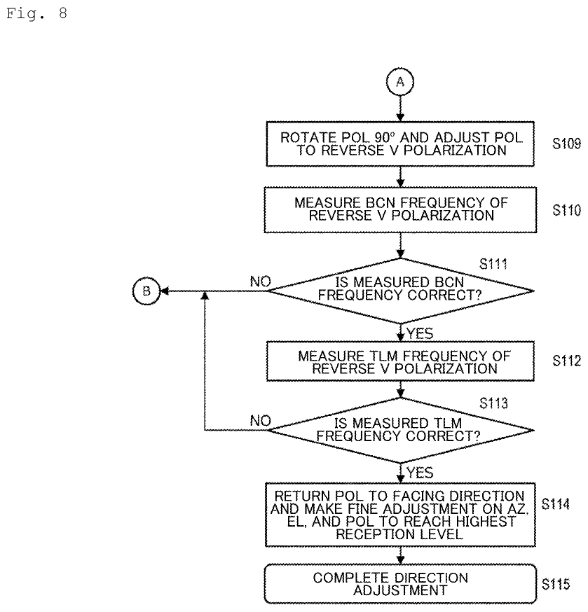

FIGS. 7 and 8 illustrate an example of the adjustment of the antenna direction. The processing in FIGS. 7 and 8 are performed by a program stored in the control unit 301 of the automatic acquisition control unit 207 of the master station device 101 illustrated in FIG. 5.

In step S101, a user of the master station device 101 turns on the device to start adjusting the antenna direction. Specifically, after the turning-on, the user instructs the control unit 301 to start adjusting the antenna direction through the operation interface (e.g., an operation button or an operation panel (not illustrated)) of the automatic acquisition control unit 207 illustrated in FIG. 5. In response to the instruction, the control unit 301 starts processing for adjusting the antenna direction of the ANT 200 to acquire the target communication satellite 103.

In step S102, the control unit 301 obtains the latitude and longitude of the installation location. Specifically, in the automatic acquisition control unit 207 of FIG. 5, the control unit 301 measures the latitude and longitude of the installation location of the master station device 101 by means of the position sensor 303.

In step S103, the control unit 301 calculates an azimuth angle, an elevation angle, and a polarization angle from the longitude of the target communication satellite 103 and the latitude and longitude of the installation location. Hereinafter the azimuth angle will be denoted as AZ (AZimuth), the elevation angle will be denoted as EL (ELevation), and the polarization angle will be denoted as POL (POLarization). Specifically, the control unit 301 calculates the directions (AZ, EL, and POL) of the target communication satellite 103 at the installation location of the portable station device 101 based on the east longitude and the polarization (e.g., H polarization) of the target communication satellite 103 in the facing direction, and the latitude and longitude of the portable station device 101. The east longitude and the polarization of the communication satellite 103 are obtained from the satellite DB 305, and the latitude and longitude of the portable station device 101 are measured in step S102.

In step S104, the control unit 301 coarsely adjusts the antenna direction according to AZ, EL, and POL that are calculated in step 5103 (coarse adjustment). Specifically, the control unit 301 controls the antenna drive unit 206 such that the three directions of AZ, EL, and POL of the ANT 200 agree with AZ, EL, and POL that are calculated in step S103. The antenna drive unit 206 includes, for example, a three-axis drive capable of separately adjusting the three directions of AZ, EL, and POL.

In step S105, the control unit 301 measures the frequency of the beacon signal (referred to as a BCN frequency) of H polarization in the facing direction. Specifically, the control unit 301 measures the BCN frequency of the beacon signal of H polarization by means of the MON 304 (measurement). The beacon signal is received via the ANT 200, the OMT 201, the LNB 203, and the DIV 204.

In step S106, the control unit 301 determines whether the BCN frequency of H polarization is correct or not with reference to the satellite DB 305 (determination). The BCN frequency is measured in step S105. If the determination result is correct (YES), the control unit 301 proceeds to the processing of subsequent step S107. Otherwise (NO) the control unit 301 returns to the processing of step S101 and performs the same processing. Specifically, if the target communication satellite 103 at X degrees east longitude in FIGS. 3 and 4 is acquired by the coarse adjustment of step S104, the measured BCN frequency of H polarization in step S105 is AHz, so that the determination result is YES. If the communication satellite 113(1) at Y degrees east longitude is erroneously acquired by the coarse adjustment of step S104, the measured BCN frequency of H polarization in step S105 is CHz, so that the determination result is NO.

In step S107, the control unit 301 measures the frequency of the telemetry signal (referred to as a TLM frequency) of H polarization in the facing direction. Specifically, the control unit 301 measures the TLM frequency of the telemetry signal of H polarization by means of the MON 304 (measurement). The telemetry signal is received via the ANT 200, the OMT 201, the LNB 203, and the DIV 204.

In step S108, the control unit 301 determines whether the TLM frequency of H polarization is correct or not with reference to the satellite DB 305 (determination). The TLM frequency is measured in step S107. If the determination result is correct (YES), the control unit 301 proceeds to processing (A) of FIG. 8. Otherwise (NO) the control unit 301 returns to the processing of step S101 and performs the same processing. Specifically, if the target communication satellite 103 at X degrees east longitude in FIGS. 3 and 4 is acquired by the coarse adjustment of step S104, the measured TLM frequency of H polarization in step S107 is CHz, so that the determination result is YES. If the communication satellite 113(1) at Y degrees east longitude is erroneously acquired by the coarse adjustment of step S104, the measured TLM frequency of H polarization in step S107 is DHz, so that the determination result is NO.

The control unit 301 performs the processing of FIG. 8 subsequent to the processing of FIG. 7.

In step S109, the control unit 301 issues a command to the antenna drive unit 206 such that the polarization angle (POL) of the ANT 200 is rotated 90° and is adjusted to reverse V polarization.

In step S110, the control unit 301 measures the BCN frequency of the beacon signal of reverse V polarization (measurement). Specifically, the control unit 301 measures the BCN frequency of the beacon signal of V polarization by means of the MON 304. The beacon signal is received via the ANT 200, the OMT 201, the LNB 203, and the DIV 204.

In step S111, the control unit 301 determines whether the BCN frequency of V polarization is correct or not with reference to the satellite DB 305 (determination). The BCN frequency is measured in step S110. If the determination result is correct (YES), the control unit 301 proceeds to the processing of subsequent step S112. Otherwise (NO) the control unit 301 returns to the processing of step S101 from (B) of FIG. 7 and performs the same processing. Specifically, if the target communication satellite 103 at X degrees east longitude in FIGS. 3 and 4 is acquired by the coarse adjustment of step S104, the measured BCN frequency of V polarization in step S110 is BHz, so that the determination result is YES. If the communication satellite 113(1) at Y degrees east longitude is erroneously acquired by the coarse adjustment of step S104, the measured BCN frequency of V polarization in step S105 is AHz, so that the determination result is NO.

In step S112, the control unit 301 measures the TLM frequency of the telemetry signal of reverse V polarization (measurement). Specifically, the control unit 301 measures the TLM frequency of the telemetry signal of V polarization by means of the MON 304 (measurement). The telemetry signal is received via the ANT 200, the OMT 201, the LNB 203, and the DIV 204.

In step S113, the control unit 301 determines whether the TLM frequency of V polarization is correct or not with reference to the satellite DB 305 (determination). The TLM frequency is measured in step S112. If the determination result is correct (YES), the control unit 301 proceeds to the processing of subsequent step S114. Otherwise (NO) the control unit 301 returns to the processing of step S101 from (B) of FIG. 7 and performs the same processing. Specifically, if the target communication satellite 103 at X degrees east longitude in FIGS. 3 and 4 is acquired by the coarse adjustment of step S104, the measured TLM frequency of the telemetry signal of V polarization in step S112 is DHz, so that the determination result is YES. If the communication satellite 113(1) at Y degrees east longitude is erroneously acquired by the coarse adjustment of step S104, the measured TLM frequency of the telemetry signal of V polarization in step S112 is BHz, so that the determination result is NO.

In step S114, the control unit 301 issues a command to the antenna drive unit 206 such that the polarization angle (POL) of the ANT 200 is returned from reverse V polarization to H polarization in the facing direction. The control unit 301 controls the antenna drive unit 206 to make a fine adjustment on the three directions of AZ, EL, and POL of the ANT 200 such that H polarization measured by the MON 304 reaches the highest reception level (fine adjustment). In the present embodiment, the control unit 301 makes a fine adjustment such that the beacon signal of H polarization reaches the highest reception level. The control unit 301 may make a fine adjustment such that the telemetry signal of H polarization reaches the highest reception level. Alternatively, the control unit 301 may make a fine adjustment such that the beacon signal or the telemetry signal of reverse V polarization reaches the highest reception level. A small deviation may occur when the polarization is returned to H polarization in facing direction.

In step S115, the control unit 301 completes the adjustment of the antenna direction.

In this way, the satellite communication system 100 according to the present embodiment makes a fine adjustment after a coarse adjustment of the antenna direction, thereby directing the antenna toward the target communication satellite 103. The satellite communication system 100 according to the present embodiment, in particular, can securely acquire the target communication satellite 103 with a combination of the frequency of the telemetry signal including polarization, even if another communication satellite is present around the target communication satellite 103 with beacon signals of overlapping frequencies.

The automatic acquisition control unit 207 of the master station device 101 can be also implemented mainly by a computer and a program. The program may be stored in advance in a storage medium or may be provided via a communication network.

As described in the embodiment, the antenna direction adjusting method, the portable station device and the antenna direction adjusting program in the satellite communication system according to the present invention can securely acquire a target communication satellite based on a combination of the frequencies of a beacon signal and a telemetry signal even if the use of the control signal of a base station device is interrupted by a wide scale disaster or the like.

### REFERENCE SIGNS LIST

100, 800 Satellite communication system

101 Portable station device (master station device)

102 Portable station device (slave station device)

103, 113, 803 Communication satellite

151 Satellite information table

200, 400 ANT

201, 401 OMT

202, 402 BUC

203, 403 LNB

204 DIV

205, 404 MODEM

206, 405 Antenna drive unit

207, 406 Automatic acquisition control unit

301, 501 Control unit

302, 502 Azimuth sensor

303, 503 Position sensor

304 MON

305 Satellite DB

801 Portable station device

802 Base station device

1. An antenna direction adjusting method in a satellite communication system comprising a portable station device,
the portable station device performs:
a coarse adjustment in which an antenna direction is calculated relative to a target communication satellite based on a longitude of the target communication satellite from satellite information about longitudes of a plurality of communication satellites, a beacon signal, and a telemetry signal and an installation position of the portable station device and an antenna direction of the portable station device is coarsely adjusted to the calculated antenna direction;
measurement of frequencies of the beacon signal and the telemetry signal that are received in the coarsely adjusted antenna direction;
determination of whether the measured frequencies of the beacon signal and the telemetry signal in the measurement are correct or not with reference to the frequencies of the beacon signal and the telemetry signal of the target communication satellite, the frequencies being stored in the satellite information; and
a fine adjustment on the antenna direction such that the beacon signal received in the coarsely adjusted antenna direction reaches a highest reception level, if the measured frequencies of the beacon signal and the telemetry signal in the measurement are correct.

2. The antenna direction adjusting method according to claim 1, wherein the information about the beacon signal and the telemetry signal indicates a frequency of polarization in a facing direction and a frequency of polarization in a reverse direction for the beacon signal and the telemetry signal, and
the antenna directions in the coarse adjustment and the fine adjustment are an azimuth angle, an elevation angle, and a polarization angle of an antenna relative to the target communication satellite.

3. A portable station device used in a satellite communication system, comprising:
a storage unit in which satellite information about longitudes of a plurality of communication satellites, a beacon signal, and a telemetry signal is stored;
a measuring unit for receiving the beacon signal and the telemetry signal from the communication satellite and measuring frequencies of the signals; and
a control unit for performing: a coarse adjustment in which an antenna direction is calculated relative to a target communication satellite based on a longitude of the target communication satellite from the satellite information and an installation position of the portable station device and an antenna direction of the portable station device is coarsely adjusted to the antenna direction calculated by controlling a drive unit in the antenna direction; determination of whether the frequencies measured by the measuring unit for the beacon signal and the telemetry signal are correct or not with reference to the frequencies of the beacon signal and the telemetry signal of the target communication satellite, the frequencies being stored in the satellite information; and a fine adjustment on the antenna direction such that the beacon signal received in the coarsely adjusted antenna direction reaches a highest reception level, if the frequencies measured by the measuring unit for the beacon signal and the telemetry signal are correct.

4. The portable station device according to claim 3, wherein the information about the beacon signal and the telemetry signal indicates a frequency of polarization in a facing direction and a frequency of polarization in a reverse direction for the beacon signal and the telemetry signal, and
the antenna directions in the coarse adjustment and the fine adjustment are an azimuth angle, an elevation angle, and a polarization angle of an antenna relative to the target communication satellite.

5. A non-transitory computer-readable storage medium storing an antenna direction adjusting program for causing a computer to perform processing performed by the control unit of the portable station device according to claim 3.
